(19) United States
(12) Patent Application Publication
(10) Pub. No.: US 2007/0276939 A1
(43) Pub. Date: Nov. 29, 2007

(54) Electronic apparatus and restarting method thereof

(75) Inventors: Yasuo Funato, Saitama-shi (JP); Takeshi Makita, Hino-shi (JP); Takuya Kawamura, Kawasaki-shi (JP); Naohisa Shibuya, Kawasaki-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/802,488

(22) Filed: May 23, 2007

(30) Foreign Application Priority Data
May 24, 2006 (JP) 2006-144449

(51) Int. Cl. G06F 15/173

(52) U.S. Cl. 709/224

(57) ABSTRACT

According to one embodiment, an electronic apparatus includes a programmable logic device which loads forming circuit information to form a counter circuit to count a value of the number of times of the system reset and to set an initial value of the counter circuit from a memory device on turning on a power source, counts the value of the number of times of the system reset by the counter circuit for each occurrence of the system reset in a current-carrying state, a processor reads in the value of the number of times of the system reset to be stored in the programmable logic device to determine whether or not the value reaches the predetermined reference number of times, and stops starting processing when the value has reached the reference number of times.

### CROSS-REFERENCE TO RELATED APPLICATIONS

This application is based upon and claims the benefit of priority from Japanese Patent Application No. 2006-144449, filed May 24, 2006, the entire contents of which are incorporated herein by reference.

### BACKGROUND

1. Field

One embodiment of the present invention relates to, for example, electronic apparatus which has a plurality of circuit blocks, for example such as digital signal processors (DSPs) and sub-processors like multi-point control units (MCUs), monitors operation states of each circuit block, and resets the circuit block with an abnormal operation occurred therein, and when the abnormal operation is still not restored, tries to make the circuit block operate normally by system reset, and relates to a restarting method thereof.

2. Description of the Related Art

In an office, or a business establishment, for example, a telephone exchange to standard telephone sets has been used. Recently, a system which connects a server with a data terminal, such as a video communication end-point and a personal computer connected thereto to the telephone exchange via a transmission path, and makes a voice communication system using the telephone exchange link with a data communication system using the server has been proposed.

By the way, in the given parallel-type system of the telephone exchange and the server, to construct a video conference, etc., a MCU has been used. To carry out high-level signal processing, such as image compression and de-compression, image synthesis, and communication control, the MCU uses a large-scale integrated circuit for each of these functions. Further, not a few of these devices are constituted by software or hardware logic, the devices are brought into a state in which they result in occurrences of an inner logical contradiction and do not operate normally sometimes because of being constituted logically. For instance, DSPs or image CODECs, etc., are brought into operation stoppages due to inner logic failures but not into component failures sometimes. Therefore, the device needs to confirm whether the components and the circuit blocks operate normally in order to improve the reliability of electronic equipment. If the system has been brought into the aforementioned inner logical contradiction, the device may restore by system or component and circuit block level restarting.

To respond such a phenomenon, the device conducts response acknowledgement to the components or the circuit blocks periodically or not periodically, and if the components or the circuit blocks are in abnormal state, such that their responses are abnormal, or they make no response, the device issues partial reset to the components or circuit blocks concerned to initialize it.

Furthermore, if the device is not restored by the partial reset to the components or the circuit blocks, the whole of the system should be reset. However, in the case of physical damage and failure, issuing the system reset cannot normally restore the device and it results in repetition of the permanent system reset through the foregoing repetition until its power source is turned off.

Conventionally, an on-vehicle electronic control device to count the number of repeated reset times by one processor by means of other processor and to stop a function of an electronic control device, when the count value exceeds the predetermined number of times, has been presented (for example, Jpn. Pat. Appln. KOKAI Publication No. 2-250124).

However, the aforementioned on-vehicle electronic control device monitors the processor, and does not monitor the components and circuit blocks. A plurality of processors being provided for the device, the device itself becomes complex and increases in costs. The device being controlled through software, even if there is no failure on a main body side, the possibility of a false operation of a CPU circuit on a count side is generally high in comparison to hardware control, and it results in insecure reliability.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram illustrating a configuration of an embodiment of an MCU as electronic equipment regarding the invention; and

FIG. 2 is an exemplary flowchart illustrating an abnormality determination and corresponding control procedure, and control content in the embodiment.

### DETAILED DESCRIPTION

Various embodiments according to the invention will be described hereinafter with reference to the accompanying drawings, In general, according to one embodiment of the invention, an electronic apparatus, comprising: a single or a plurality of signal processing units; a processor which individually detects a part of or a whole of operation states of the plurality of signal processing units, and carries out system reset to reset allover the apparatus including the single or the plurality of signal processing units, when result in detection indicates an existence of any abnormal signal processing unit; a programmable logic device which loads forming circuit information to form a counter circuit to count a value of the number of times of the system reset and to set an initial value of the counter circuit from a memory device on turning on a power source, counts the value of the number of times of the system reset by the counter circuit for each occurrence of the system reset in a current-carrying state, and is independent from the system reset with respect to a register to record the count value; wherein the processor reads in the value of the number of times of the system reset to be stored in the programmable logic device to determine whether or not the value reaches the predetermined reference number of times, and stops starting processing when the value has reached the reference number of times.

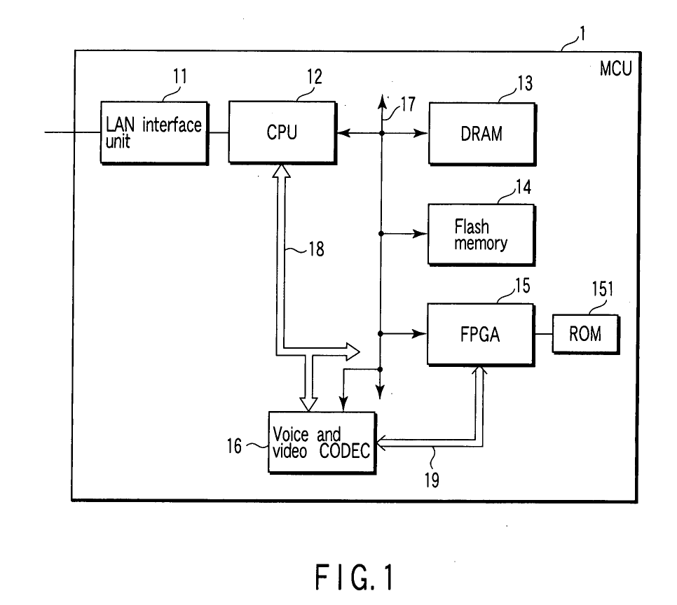

FIG. 1 is a block diagram depicting a configuration of an embodiment of an MCU as electronic equipment regarding the invention, and the symbol 1 indicates the MCU.

An MCU 1 includes a local area network (LAN) interface unit 11, a CPU 12, a DRAM 13, a flash memory 14, a field programmable gate array (FPGA), and a voice and video CODEC 16. Among of them, the CPU 12, the DRAM 13, the flash memory 14, the FPGA 15 and the voice and video CODEC 16 are connected by a CPU bus 17 to one another.

A peripheral component interconnect (PCI) bus 18 connects the CPU 12 and the voice video CODEC 16 to each other, and a local bus 19 connects the voice and video CODEC 16 and the FPGA 15 to each other.

The LAN interface unit 11 carries out interface processing to and from a LAN under the control from the CPU 12.

The DRAM 13 is a work memory to be used for operations of the CPU 12. The flash memory 14 stores control program data and system setting data to be used by the CPU 12.

The CPU 12 achieves operations as the MCU 1 by generally controlling each part of the MCU 1 based on the program stored in the DRAM 13 and the flash memory 14.

A ROM 151 is connected to the FPGA 15. The ROM 151 stores a program as forming circuit information for forming a counter circuit to count the number of reset times in addition to the information for forming a voice and image synthesis circuit, or the like, and for setting the initial value of the counter circuit. That is, the program stored in the ROM 151 is loaded in the FPGA 15 when a power source is turned on, and the programmed counter circuit is formed in addition to the voice and image synthesis circuit and a watchdog timer by a configuration operation. When stopping the timer clear of the watchdog timer, the CPU 12 conducts system reset and increments a abnormality of the number of reset times. Turning on the power source after turning off the power source reconstitutes a counter circuit of the number of reset times is reconstituted in the FPGA 15 and the count value is set to the initial value. The register to record a value of the number of reset times in the FPGA 15 is independent from the system reset.

Further, the FPGA 15 carries out the voice and image synthesis processing by means of the program stored in the ROM 151.

The voice and video CODEC 16 executes voice and image recognition processing under the control by the CPU 12.

The operations of the MCU 1 configured by such a configuration given above will be described hereinafter.

In constituting a video conference, it is presumed that video and voice packets arrive at the LAN interface 11 from end points on the LAN. The video and voice data included in the video and voice packet is transferred to the voice and video CODEC 16 via the CPU 12 and the PCI bus 18.

Usually, the video and the voice data transferred via a network has been compressed, and when the video and voice data has arrived, the voice and video CODEC 16 extends the compressed data to restore it into linear data. The linear data is transferred to the FPGA 15 though the local bus 19. The FPGA 15 synthesizes the linear data from each end point to generate voice and video data for a distribution in the video conference. The video and voice data concerned is re-compressed through the local bus 19 and the voice and video CODEC 16, packetized by the CPU 12 through the PCI bus 18 to be transferred to the LAN interface unit 11, and transmitted for each end point composing the video conference on the LAN from the LAN interface unit 11.

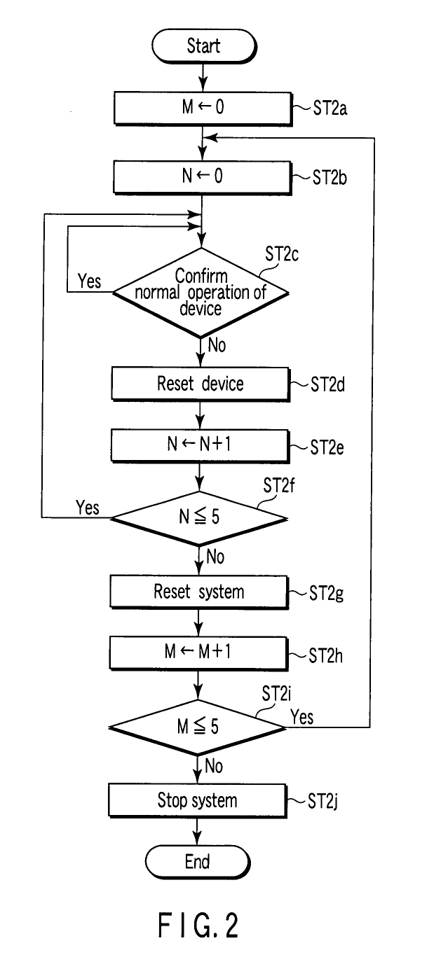

Meanwhile, in such video conference processing, the CPU 12 performs abnormality determination and corresponding control as follows. FIG. 2 is a flowchart illustrating a control procedure and control content of the control procedure and the corresponding control.

That is to say, the CPU 12 detects operation states of each part including the LAN interface unit 11 and the voice and video CODEC 16. In this case, the CPU 12 sets an initial value (M=0) of the number of system reset times to reset the whole of each part including the LAN interface unit 11 and the voice and video CODEC 16 (block ST2a), and sets an initial value of the number of device reset times to reset by each part unit (block ST2b). It is supposed that any abnormality occurs at the voice and video reset CODEC 16. The CPU 12 then sifts from a block ST2c to a block ST2d to reset the voice and video CODEC 16 with abnormality occurred therein. After this, the CPU 12 increments a value of the number of device-reset times (block ST2e), and determines whether or not the value N of the number of times reaches a value (N=5) of the number of reset setting times (block ST2f).

The count of the number of reset times is stored the number of times in a nonvolatile memory. If the value of the number of times is recorded on a nonvolatile memory, the CPU 12 usually clears the memory so as to avoid instability at the time of starting, so that even if the CPU 12 resets the system, the number of times is deleted at every system reset. Therefor, the number of times results in it being recorded in a rewritable nonvolatile memory like the flash memory 14.

However, the memory is being nonvolatile; the value of the number of reset times is not cleared even at power off/on. Accordingly, in the case in which there is no logical failure, such as a latch up phenomenon, and also there is no physical failure, and when the number of reset times reaches the number of reset predetermined times prior to the power on/off although the failure may be restored by means of the power on/off, the CPU 12 cannot start the MCU 1 even if the cause is eliminated by the power on/off after this.

In this case, it is necessary to artificially clear the flash memory 14; it poses the necessity of rewriting through an emulator, etc., or the necessity of a method through a specific circuit designed especially, and it results in an increase in costs and results in consumption of much labor.

Therefore, in the present invention, the MCU 1 forms the counter of the number of reset times by the FPGA 15, further, it counts the number of system reset times by hard logic in the FPGA 15 but not by the CPU 12. The programmable logic device like the FPGA 15 forms the circuit programmed by a configuration operation in turning on the power source of the system, but the device reforms the circuit only by an exclusive reconfiguration signal and does not reform through the system reset.

Accordingly, forming the counter circuit by the FPGA 15 making it possible for the content not to be rewritten by the system reset, the counter circuit is appropriate to count the number of system reset times, and the counter circuit being reformed by turning on/off the power source, the counter circuit has a property to clear the counter by turning on/off the power source.

Until the value of the number of system reset times to be stored in the FPGA 15 reaches the value of the reset predetermined times, the CPU 12 shifts from a block 2i to the block 2c to carry out the device reset, and performs the system reset after repeating the device reset of a fixed number of times (block ST2g). The counter circuit of the reset inside the FPGA 15 increments the value of M of the resister of the number of system reset times to be stored in the FPGA 15 (block ST2h). On starting, the CPU 12 reads in the value of M of the resister of the number of reset times to determine whether or not the value of M has reached the value of the number of reset preset times (M=5) (block ST2i).

Here, if the value M of the register of the value of the number of times has not reached the value of the number of reset preset times, the CPU 12 repeatedly executes the processing from the block ST2b to the block 2i; however if the value M has reached the value thereof, the CPU 12 stops the start processing through HALT, etc., or turns off the power source of the MCU 1 (block ST2j).

As mentioned above, in the foregoing embodiment, the programmable device forms the reset counter circuit, the MCU 1 uses the FPGA 15 to automatically set the value of the resister of the value of the number of system reset times to the initial value when the power sources changes its state from an on state to an off state, carries out the device reset by signal processing unit that is the LAN interface unit 11 and the voice and video CODEC 16, and when the value of the number of device reset times to be stored in the FPGA 15 has reached the value of the number of reset preset times, the MCU 1 immediately shifts to the system reset.

In the aforementioned embodiment, the CPU 12 holds the value of the number of system reset times in the FPGA 15, and also determines whether or not the value thereof reaches the value of the number of reset preset times, and in the case of reaching, the CPU 12 stops the start processing or turns off the power source of the MCU 1.

Accordingly, the MCU 1 may try the restoring as much as possible, and avoid the unlimited repetition of the system reset even if the restoring is impossible.

### Other Embodiment

The invention is not limited to the given embodiment. For example, the aforementioned embodiment having described by taking the case, in which the voice and video CODEC unit of the MCU is reset, as an example, the invention is applicable to, for instance, other circuit block, such as a FPGA, or to electronic equipment other than the MCU. In a word, the invention is applicable to any electronic equipment as long as it is one with a plurality of signal processors carrying out signal processing differing from one another mounted thereon.

The aforementioned embodiment having described an example using the FPGA, electronic equipment using a programmable logic device other than the FPGA may be usable.

Other than this, as to the functional configuration of the MCU, the procedure and content of the abnormality determination and the corresponding control, and the like, various modifications may be embodied without departing from the spirit of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus, comprising:
a single or a plurality of signal processing units;
a processor which individually detects a part of or a whole of operation states of the plurality of signal processing units, and carries out system reset to reset allover the apparatus including the single or the plurality of signal processing units, when result in detection indicates an existence of any abnormal signal processing unit;
a programmable logic device which loads forming circuit information to form a counter circuit to count a value of the number of times of the system reset and to set an initial value of the counter circuit from a memory device on turning on a power source, counts the value of the number of times of the system reset by the counter circuit for each occurrence of the system reset in a current-carrying state, and is independent from the system reset with respect to a register to record the count value; wherein
the processor reads in the value of the number of times of the system reset to be stored in the programmable logic device to determine whether or not the value reaches the predetermined reference number of times, and stops starting processing when the value has reached the reference number of times.

2. The electronic apparatus according to claim 1, further comprising:
a controller which partially resets a part or a whole of the plurality of signal processing units, wherein
the processor makes the controller carry out partial reset of the corresponding signal processing unit when individually monitors the part of or the whole of operation states of the plurality of signal processing units and results in detection of an existence of any abnormal signal processing unit, and carry out the system reset when the partial reset does not restore the abnormal signal processing unit although the processor repeats the partial reset up to the predetermined reference number of times.

3. The electronic apparatus according to claim 1, further comprising:
a power source controller which turns off the power source, wherein
the processor reads in the value of the number of times of the system reset to be stored in the programmable logic device on starting processing, determines whether or not the value reaches the predetermined reference number of times, and makes the controller carry out turning off the power source if the value has reached the reference number of times.

4. The electronic apparatus according to claim 1, wherein the programmable logic device is a field programmable gate array.

5. A restarting method for electronic apparatus which includes a processor and a single or a plurality of signal processing units, the method comprising:
carrying out system reset to reset allover the equipment including the single or the plurality of signal processing units, when the processor individually monitors a part of or a whole of operation states of the plurality of signal processing units and results in detection of an existence of any abnormal signal processing unit;
counting a value of the number of times of the system reset by a programmable logic device independent from the system reset with respect to a register to record the count value for each occurrence of the system reset in a current-carrying state;
recording the count value of the number of times of the system reset in the programmable logic device;
reading in the value of the number of times of the system reset to be stored in the programmable logic device to determine whether or not the value reaches a predetermined reference number of times by the processor; and
carrying out either stopping of starting processing or turning off the power source if the value has reached the reference number of times by the processor.

6. The method according to claim 5, wherein the programmable logic device loads forming circuit information to form a counter circuit to count a value of the number of times of the system reset and to set an initial value of the counter circuit from a memory device on turning on a power source.
